(19) United States
(12) Patent Application Publication
(10) Pub. No.: US 2019/0141026 A1
(43) Pub. Date: May 9, 2019

(54) BLOCKCHAIN BASED DEVICE AUTHENTICATION

(71) Applicant: General Electric Company, Schenectady, NY (US)

(72) Inventors: Atul Chandrakant Kshirsagar, San Ramon, CA (US); Vineet Banga, San Ramon, CA (US)

(21) Appl. No.: 15/806,036

(22) Filed: Nov. 7, 2017

(51) Int. Cl. H04L 29/06

(52) U.S. Cl. CPC H04L 63/0807; H04L 63/061; H04L 63/0853; H04L 63/123; H04L 63/0442

(57) ABSTRACT

An authentication system receives an authentication request from a client device. The authentication request includes a unique token assigned to the device that has been encrypted using a private key. In response to receiving the request, the authentication system verifies, based on the unique token received in the authentication request, that the device is registered with the authentication system, and accesses, from a blockchain, integrity measurement information for the device. The integrity measurement information was previously generated in connection with the device. The authentication system generates an access token for the device factoring in the integrity measurement information, and provides the access token to the device. The access token provides the device with access to at least a first service.

### TECHNICAL FIELD

The present disclosure generally relates to the technical field of special-purpose machines that facilitate network security, including computerized variants of such special-purpose machines and improvements to such variants, and to the technologies by which such special-purpose machines become improved compared to other special-purpose machines that facilitate network security. In particular, the present disclosure addresses systems and methods for blockchain based device authentication.

### BACKGROUND

Most people are familiar with the term information Technology (IT), which covers the spectrum of technologies for information processing, including software, hardware, communications technologies and related services. Operation Technology (OT) is a relatively newer term that refers to hardware and software that detects or causes a change through the direct monitoring and/or control of physical devices, processes and events in the enterprise. For example, OT networks interconnect industrial control systems such as programmable logic controllers, supervisory control and data acquisition systems, distributed control systems, process control domains, safety instrumented systems, and building management and automation systems.

As many organizations are discovering, the Industrial Internet is a huge new opportunity for growth and efficiency. To realize this value, OT environments need to be connected. With production systems becoming more interconnected, the exposure to cyber incidents increases. Attacks and disruptions on critical infrastructure put reputation, production, people, and profits at risk.

Traditionally, OT networks have operated separately from IT networks, For example, OT networks utilized proprietary protocols optimized for the required functions, some of which have become adopted as ‘standard’ industrial communications protocols (e.g., DP3, Modbus, Profibus, RTU, CANBUS, HART, DeviceNet). More recently, IT-standard network protocols are being implemented in OT devices and systems to reduce complexity and increase compatibility with more traditional IT hardware (e.g., TCP/IP). This has led to a demonstrable reduction in security for OT systems.

Network security systems are designed to protect critical infrastructure, control systems and OT assets from cyber threats and vulnerabilities by monitoring and blocking malicious activity and misconfiguration to promote OT safety and protect productivity. Device authentication is one technique used by network security systems to provide security control. Devices in the network are assigned a unique token that the respective device provides to the network security system for authentication. Once a device has been authenticated, the network security system provides the device with an access token that enables the device to access services until the access token expires. One problem with this technique is that the device itself may be tampered with, while still retaining its unique token. As a result, the tampered with device would be able to properly authenticate with the network security system. Accordingly, improvements are needed.

### BRIEF DESCRIPTION OF THE DRAWINGS

The drawings illustrate example embodiments of the present disclosure and do not limit the scope of the present disclosure.

FIG. 1 a system in which an authentication system uses both a unique token and an integrity measurement value to authenticate a device, according to some example embodiments.

FIG. 2 is a block diagram of the authentication system, according to some example embodiments.

FIG. 3 is a block diagram of the edge device, according to some example embodiments.

FIG. 4 is a block diagram of the service provider, according to some example embodiments.

FIG. 5 is a flowchart illustrating a method for authorizing an edge device, according to an example embodiment.

FIG. 6 is a flowchart illustrating a method for requesting a service, according to an example embodiment.

FIG. 7 illustrates a cloud based architecture for authorizing an edge device, according to some example embodiments.

FIG. 8 is a block diagram illustrating an example software architecture, which may be used in conjunction with various hardware architectures herein described.

FIG. 9 is a block diagram illustrating components of a machine, according to some example embodiments, able to read instructions from a machine-readable medium (e.g., a machine-readable storage medium) and perform any one or more of the methodologies discussed herein.

### DETAILED DESCRIPTION

To provide improved authentication security, an authorization system uses both a unique token and an integrity measurement value to authenticate a device. A unique token is assigned to a device when the device registers with an authentication system. After registration, the device begins periodically transmitting an integrity measurement value to the network authorization system. The integrity measurement value is calculated by the device and indicates the relative health of the device based on data gathered by the device. The authorization system stores the received integrity measurement values in an authorization blockchain along with data identifying the device.

The device authenticates with the authorization system to receive an access token, which the device can use to access available services. The access token has an associated expiration time, after which the access token is void and the device has to again authenticate with the authentication system to receive a new access token. To authenticate with the authentication system, the device transmits an authentication request to the authentication system that includes the unique token assigned to the device. The device encrypts the unique token prior to transmission.

Upon receiving the authentication request, the authentication system verifies the unique token and accesses the latest integrity measurement value for the device from the authentication blockchain. The authentication system then generates an access token for the device based on the integrity measurement value and provides the generated access token to the device. For example, in some embodiments, the authentication system compares the integrity measurement value to a threshold integrity measurement value to ensure that the device has not been tampered with. The authentication system does not provide the access token to the device if the integrity measurement value is determined to be less than the threshold integrity measurement value.

In other embodiments, the authentication system appends the integrity measurement value to the access token and provides the access token to the device. In this type of embodiments, a service provider providing a service requested by the device determines whether the integrity measurement value meets a threshold integrity measurement value sufficient for accessing the service. The service provider would deny a request for the service if the integrity measurement value is less than the threshold integrity measurement value.

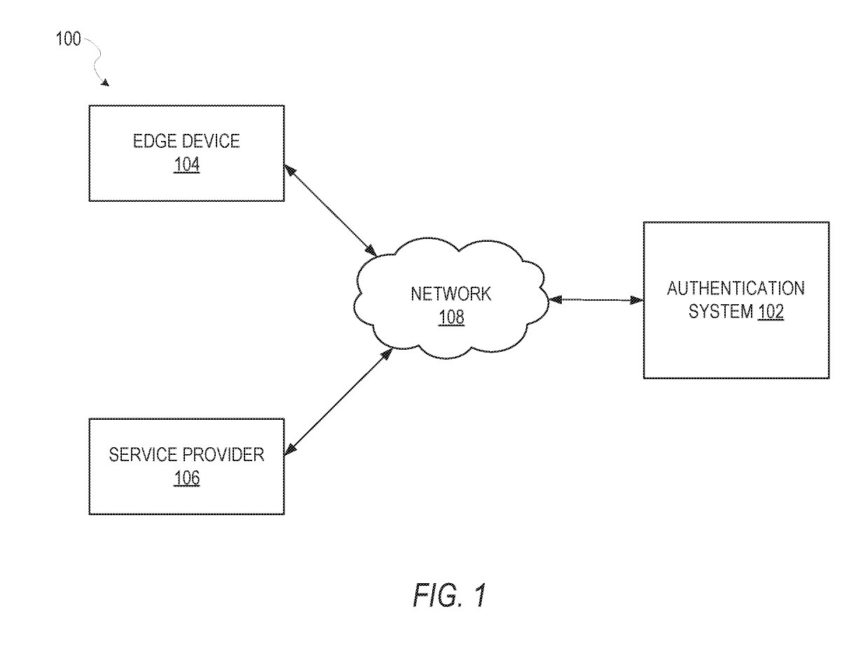

FIG. 1 is a system 100 in which an authentication system 102 uses both a unique token and an integrity measurement value to authenticate a device, according to some example embodiments. To avoid obscuring the inventive subject matter with unnecessary detail, various functional components (e.g., modules) that are not germane to conveying an understanding of the inventive subject matter have been omitted from FIG. 1. However, a skilled artisan will readily recognize that various additional functional components may be supported by the shown devices to facilitate additional functionality that is not specifically described herein. Furthermore, the various functional modules depicted in FIG. 1 may reside on a single computing device or may be distributed across several computing devices in various arrangements such as those used in cloud-based architectures (e.g., platform as a service). Further, the various functional modules, engines, etc., depicted in FIG. 1 may be implemented in either physical devices, and/or virtual devices.

As shown, the system 100 includes an authentication system 102, edge device 104 and server 106 connected to and configured to communicate with each other through use of a communication network 108. The communication network 108 may be any type of network, including a local area network (“LAN”), such as an intranet, a wide area network (“WAN”), such as the internet, or any combination thereof. Further, the communication network 108 can be a public network, a private network, or a combination thereof. The communication network 10 can be implemented using any number of communication links associated with one or more service providers, including one or more wired communication links, one or more wireless communication links, or any combination thereof. Additionally, the communication network 108 can be configured to support the transmission of data formatted using any number of protocols.

The system 100 may include both an IT network and an OT network. For example, the edge device 104 may be either a traditional IT device (e.g., computer server, laptop, mobile computing device, etc.), or OT device (e.g., industrial machine, valve, pump, etc.). Further, although one edge device 104 is show, this is only for ease of explanation and is not meant to be limiting. Hence, the system 100 may include any number and variety of edge devices 104, such as a combination of traditional IT devices (e.g., computer servers, laptops, mobile computing devices, etc.), and OT devices (e.g., industrial machinery, valves, pumps, etc.).

The service provider 106 is one or more computing devices configured to provide software services to the edge device 104. For example, the edge device 104 transmits a request for a service to the service provider 106, such as a read request, write request, etc., and the service provider 106 provides the requested service. Although only one service provider 106 is shown, this is only for ease of explanation and is not meant to be limiting. The system 100 can include any number of service providers 106 and this disclosure anticipates any such embodiments.

The authentication system 102 manages device authentication for edge device 104 to provide security control and access to the service provider 106. For example, the authentication system 102 issues an access token to the edge device 104 that the edge device 104 includes in requests transmitted to the service provider 16 for services. The service provider 106 denies requests from edge device 104 that do not include a valid access token. The access token includes an expiration time, after which the access token is no longer valid for use by the edge device 104 to request services from the service provider 106. Hence, the edge device 104 repeatedly authenticates with the authentication system 102 to receive valid access tokens to request services.

To authenticate with the authentication system 102, the edge device initially 104 registers with the authentication system 102. For example, the edge device 104 registers with the authentication system 104 when the edge device 104 is added to the system 100. During registration, the authentication system 102. assigns the edge device a unique token that is stored by the edge device 104 and thereafter used by the edge device 104 to authenticate with the authentication system. Once registered, the edge device 104 can begin authenticating with the authentication system 102 to retrieve access tokens that the edge device 104 can use to access services from service provider 106.

The authentication system 102 uses both the unique token and an integrity measurement value to authenticate the edge device 104. The integrity measurement value is a value or collection of values that indicate a relative health of the edge device 104. The edge device 104 gathers data (e.g., from internal sensors of the edge device 104) and calculates the integrity measurement value, which it periodically transmits to the authentication system 104. Upon receiving an authorization request from the edge device 104 that includes the unique token, the authentication system 102 uses the unique token to verify that the edge device 104 has registered with the authentication system 102 and gathers the latest integrity measurement value received from the edge device 104. The authentication system 104 then generates an access token based on the integrity measurement value.

In some embodiments, the authentication system 102 appends the integrity measurement value to the access token, which is then returned to the edge device 104. The edge device 104 provides the received access token to the service provider 106 when requesting services. The service provider 106 uses the appended integrity measurement value to determine whether to approve or deny the service request. For example, the service provider 106 compares the integrity measurement value to a threshold integrity measurement value to determine whether the integrity measurement value meets or exceeds the threshold integrity measurement value. The service provider 106 approves the service request if the integrity measurement value meets or exceeds the threshold integrity measurement value, and denies the service request if the integrity measurement value does not meet or exceed the threshold integrity measurement value.

In some embodiments, the authentication system 102 uses the integrity measurement value to determine whether to return an access token to the edge device 104. For example, the authentication system 102 compares the integrity measurement value to a threshold integrity measurement value to determine whether the integrity measurement value meets or exceeds the threshold integrity measurement value. The authentication system 102 authenticates the edge device 102 and returns an access token if the integrity measurement value meets or exceeds the threshold integrity measurement value, and denies the authentication request (i.e., does not return an access token) if the integrity measurement value does not meet or exceed the threshold integrity measurement value.

Using both the unique token and the integrity measurement value for authentication safeguards against instances in which an edge device 104 has been physically tampered with. For example, in systems that use only the unique token for authentication, an edge device 106 that has been tampered with may still use its unique token to receive an access token. Utilizing the integrity measurement value in addition to the unique token safeguards from this scenario by providing the authentication system 102 with the integrity measurement value indicating whether the edge device 104 has been tampered with, which the authentication system 102 and/or the service provider 106 can use to approve or deny requests.

The authentication system 102 uses an authentication blockchain to store data and authenticate the edge device 104. For example, the authentication system 102 adds a new entry to the authentication blockchain for each integrity measurement value received from the edge device 104. Upon receiving an authentication request from the edge device 104, the authentication system 102 verifies the unique token and accesses the latest integrity measurement value for the edge device 104 from the authentication blockchain. The authentication system 102 then generates an access token for the edge device 104 based on the integrity measurement value and provides the generated access token to the edge device 104. Using blockchain technology to store integrity measurement values provides several advantages. For one blockchain reduces the cost of setting up a trusted system. Given the permissioned nature of blockchain, it is not a completely trustless system. However, blockchain still allows the trust to be established quickly and at a much lower cost. Establishing the root of trust for edge devices on the blockchain allows parties to freely integrate with a common system, thereby lowering the cost of maintaining several private proprietary systems.

Another advantage of using blockchain is an improved security model. Proprietary systems built on conventional database technology are always susceptible to internal hacks. The tamper proof nature of the blockchain and the fact that peers would be distributed across the participants on the blockchain provides a higher degree of assurance against internal malicious actors. Anchoring a root of trust for the edge device 104 in the blockchain is the corner stone for securing edge communication to services provided by the service provider 106

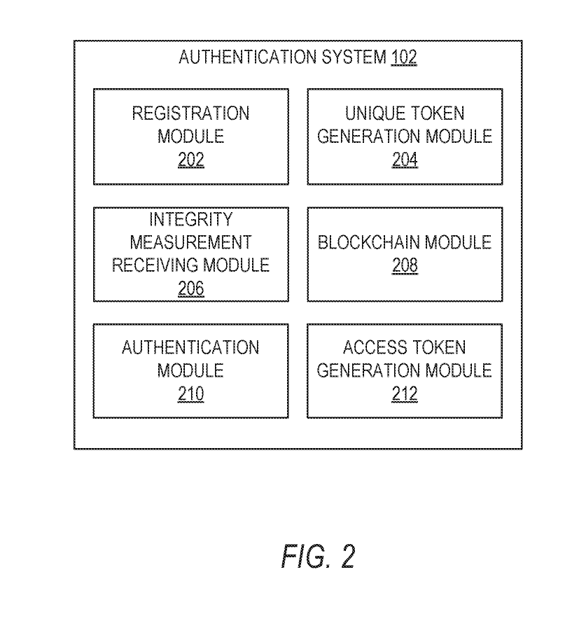

FIG. 2 is a block diagram of the authentication system 102, according to some example embodiments. To avoid obscuring the inventive subject matter with unnecessary detail, various functional components (e.g., modules) that are not germane to conveying an understanding of the inventive subject matter have been omitted from FIG. 2. However, a skilled artisan will readily recognize that various additional functional components may be supported by the authentication system 102 to facilitate additional functionality that is not specifically described herein. Furthermore, the various functional modules depicted in FIG. 2 may reside on a single computing device or may be distributed across several computing devices in various arrangements such as those used in cloud-based architectures.

As shown, the authentication system 102 includes a registration module 202, a unique token generation module 204, an integrity measurement receiving module 206, a blockchain module 208, an authentication module 210, and an access token generation module 212. The registration module 202 registers the edge device 104 with the authentication system 102. The edge device 104 communicates with the authentication system 102 to initially register. For example, the edge device 102 communicates with the authentication system 102 when the edge device is added to the system 100. Alternatively, the registration module 202 scans the network for newly added devices to register.

To register the edge device 104 with the authentication system 102, the registration module 202 assigns the edge device 104 a unique token which the edge device 104 uses to authenticate with the authentication system 102. The unique token generation module 204 generates the unique token using any known technique in the art. Once the unique token is generated by the unique token generation module 204, the registration module 202 provides the unique token to the edge device 104. The unique token is stored by the edge device 104 and used to authenticate the edge device 104 with the authentication system 102.

Upon registering with the authentication system 102, the edge device begins periodically transmitting an integrity measurement value to the authentication system 102. The integrity measurement value may be a single or multiple values that describe the relative health of the edge device 104. The integrity measurement receiving module 206 receives the integrity measurement values that are periodically transmitted by the edge device 104. The authentication system 102 stores the gathered integrity measurement values in an authentication blockchain. For example, the block chain module 208 handles storing and accessing data from the security blockchain. Once stored, the integrity measurement value is later used to authenticate the edge device 104.

The authentication module 210 handles authentication requests from the edge device 104. To authenticate with the authentication system 102, the edge device 104 transmits an authentication request to the authentication system 102. The authentication request includes the unique token assigned to the edge device 104. The authentication module 210 receives the authentication request and uses the unique token to verify that the edge device 104 has registered with the authentication system 102. In some embodiments, the unique token in the authentication request may be encrypted. For example, the edge device 104 encrypts the unique token using a private key prior to transmitting the authentication request. In this type of embodiment, the authentication module 210 decrypts the unique token when the authentication request is received. For example, the authentication module 210 decrypts the unique token using a public key.

The authentication module 210 also gathers the latest integrity measurement value for the edge device 104. For example, the authentication module 210 communicates with the blockchain module 208 to have the integrity measurement value gathered from the authentication blockchain. Once the integrity measurement value has been gathered, the authentication module 210 has an access token generated based on the integrity measurement value. This can be performed in several ways.

In some embodiments, the authentication module 210 determines whether an access token should be provided to the edge device 104 based on the integrity measurement value. For example, the authentication module 210 compares the integrity measurement value to a threshold integrity measurement value. If the integrity measurement value meets or exceeds the threshold integrity measurement value, the authentication module 210 determines that an access token should be provided to the edge device 104. The authentication module 210 then causes the access token generation module 212 to generate an access token for the edge device 104, which the authentication module 102 then provides to the edge device 104.

Conversely, if the integrity measurement value does not meets or exceeds the threshold integrity measurement value (i.e., the integrity measurement value is below the threshold integrity measurement value), the authentication module 210 determines that an access token should not be provided to the edge device 104. Hence, the authentication request is denied and the edge device 104 is not provided with an access token.

In this type of embodiment, the access token generated by the access token generation module 212 may simply be an access token that is usable by the edge device 104 to request services from the service provider, or an access token appended with additional data. For example, the access token generation module 212 may append the integrity measurement value to the access token or append an integrity measurement value range to the access token. An integrity measurement value range indicates a range of integrity measurement values in which the integrity measurement value lies.

In other embodiments, the authorization module 210 does not compare the integrity measurement value to a threshold integrity measurement value. Rather, the authorization module 210 simply causes the access token generation module 212 to generate an access token for the edge device 104, which is then provided to the edge device 104. In this type of embodiment, the access token generation module 212 appends additional data to the access token, either the integrity measurement value or an integrity measurement value range.

In embodiments in which the access token is appended with additional data (e.g., the integrity measurement value or the integrity measurement value range), the service provider 106 may use the appended data to determine whether to approve or deny a request received from the edge device 104 for a service provided by the service provider 106. For example, the service provider 106 may compare the integrity measurement value to a threshold integrity measurement value to determine whether to approve or deny the service request. Alternatively, the service provider 106 may compare the integrity measurement value range to a threshold integrity measurement value range to determine whether to approve or deny the service request.

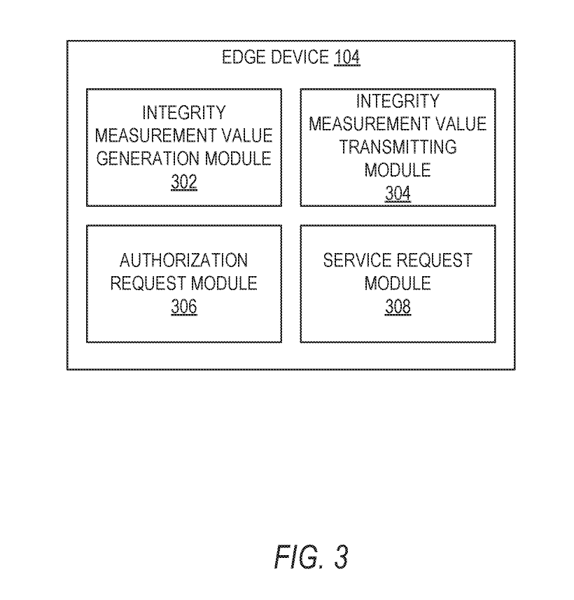

FIG. 3 is a block diagram of the edge device 104, according to some example embodiments. To avoid obscuring the inventive subject matter with unnecessary detail, various functional components (e.g., modules) that are not germane to conveying an understanding of the inventive subject matter have been omitted from FIG. 3. However, a skilled artisan will readily recognize that various additional functional components may be supported by the edge device 104 to facilitate additional functionality that is not specifically described herein. Furthermore, the various functional modules depicted in FIG. 3 may reside on a single computing device or may be distributed across several computing devices in various arrangements such as those used in cloud-based architectures.

As shown, the edge device 104 includes an integrity measurement value generation module 302, an integrity measurement value transmitting module 304, an authorization request module 306, and a service request module 308. The integrity measurement value generation module 302 generates integrity measurement values for the edge device 104. The integrity measurement value indicates a relative health of the edge device 104. For example, the integrity measurement value generation module 302 gathers sensor data describing performance of the edge device, which is then used to generate the integrity measurement value.

The integrity measurement value transmitting module 304 periodically transmits the integrity measurement values to the authentication system 102. For example, the integrity measurement value transmitting module 304 based on predetermined schedule or time intervals. As another example, the integrity measurement value transmitting module 304 transmits the integrity measurement value as an updated integrity measurement value is generated by the integrity measurement value generation module 302.

The authorization request module 306 generates and transmits authorization requests to the authentication system 102. The authorization request module 306 generates an authorization request when the edge device 104 does not have an access token or has an expired access token. To generate the authorization request, the authorization request module 306 encrypts the unique token assigned to the edge device 104. For example, the authorization request module 306 encrypts the unique token using a private key. Once the unique key is encrypted, the authorization request module 306 transmits the authorization request including the encrypted unique token to the authorization system.

The service request module 308 transmits requests to the service provider 106 for services, such as read requests, write requests, etc. The service request module 308 includes the access token received from the authorization system 102 in the request.

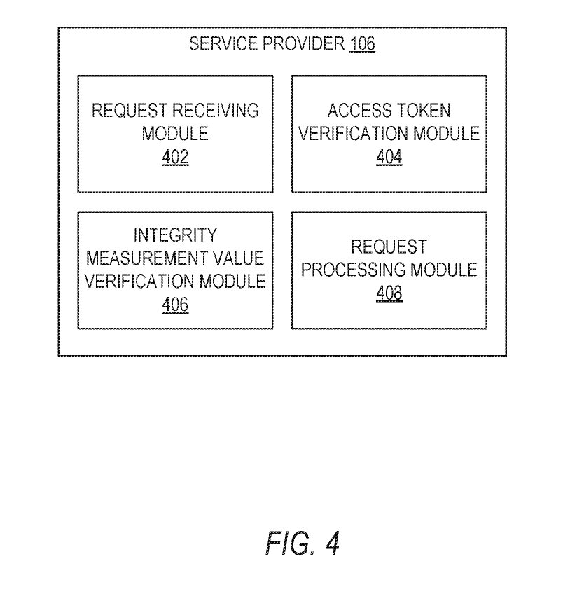

FIG. 4 is a block diagram of the service provider 106, according to some example embodiments. To avoid obscuring the inventive subject matter with unnecessary detail, various functional components (e.g., modules) that are not germane to conveying an understanding of the inventive subject matter have been omitted from FIG. 4. However, a skilled artisan will readily recognize that various additional functional components may be supported by the service provider 106 to facilitate additional functionality that is not specifically described herein. Furthermore, the various functional modules depicted in FIG. 4 may reside on a single computing device or may be distributed across several computing devices in various arrangements such as those used in cloud-based architectures.

As shown, the service provider 106 includes a request receiving module 402, an access token verification module 404, an integrity measurement value verification module 406, and a request processing module 408. The request receiving module 402 receives requests from the edge device 104 for a service provided by the service provider 106. The request includes an access token.

The access token verification module 404 verifies that a received request includes a valid access token. For example, the access token verification module 404 determines whether the access token has expired. If the access token has expired, the access token verification module 404 denies the request.

The integrity measurement value verification module 406 verifies that an integrity measurement value or integrity measurement value range appended to the request is sufficient to access the requested service. For example, the integrity measurement value verification module 406 compares the integrity measurement value or the integrity measurement value range to a threshold integrity measurement value or integrity measurement value range respectively. If the integrity measurement value verification module 406 determines that the integrity measurement value does not meet or exceed the threshold, the integrity measurement value verification module 406 denies the request.

In some embodiments, the integrity measurement value verification module 406 uses a single threshold integrity measurement value for all requests. Alternatively, the integrity measurement value verification module 406 may use different integrity measurement value based on, for example, the requested service, requesting edge device 104, time of day, etc.

The request processing module 408 processes an approved request. For example, the request processing module 408 processes requests that have a valid access token and are appended with an integrity measurement value that meets or exceeds the appropriate threshold integrity measurement value. Processing the request includes providing the requested software service.

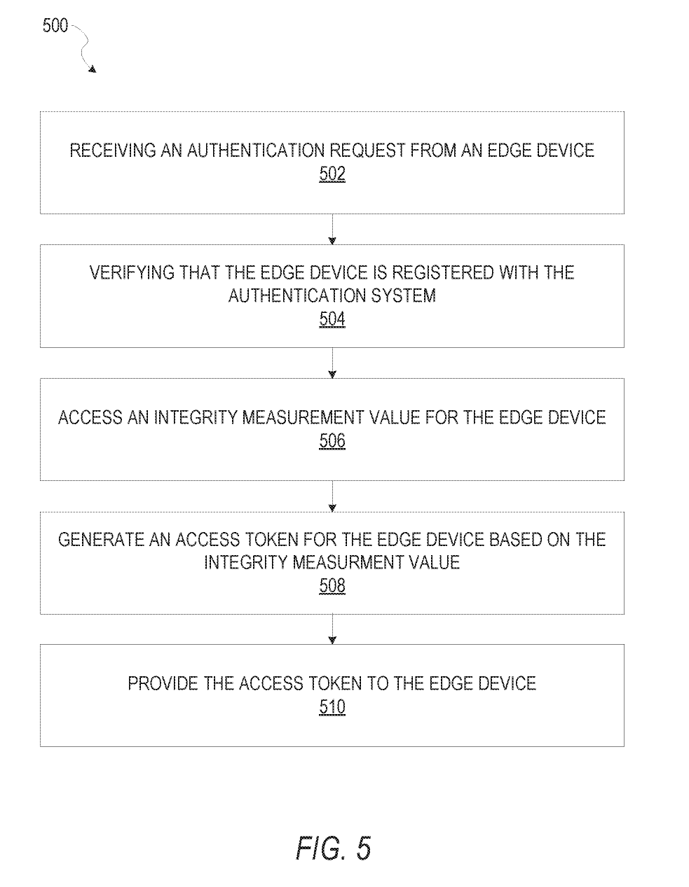

FIG. 5 is a flowchart illustrating a method 500 for authorizing an edge device 104, according to an example embodiment. The method 500 may be embodied in computer-readable instructions for execution by one or more computer processors such that the operations of the method 500 may be performed in part or in whole by the authorization system 102; accordingly, the method 500 is described below by way of example with reference thereto. However, it shall be appreciated that at least some of the operations of the method 500 may be deployed on various other hardware configurations and the method 500 is not intended to be limited to the authorization system 102.

At operation 502, the authentication module 210 receives an authentication request from an edge device 104. To authenticate with the authentication system 102, the edge device 104 transmits an authentication request to the authentication system 102. The authentication request includes the unique token assigned to the edge device 104.

At operation 504, the authentication module 210 verifies that the edge device 104 is registered with the authentication system 102. In some embodiments, the unique token in the authentication request may be encrypted. For example, the edge device 104 encrypts the unique token using a private key prior to transmitting the authentication request. In this type of embodiment, the authentication module 210 decrypts the unique token when the authentication request is received. For example, the authentication module 210 decrypts the unique token using a public key.

At operation 506, the blockchain module 208 accesses an integrity measurement value for the edge device. For example, the authentication module 210 communicates with the blockchain module 208 to have the integrity measurement value gathered from the authentication blockchain.

At operation 508, the access token generation module 212 generates an access token for the edge device based on the integrity measurement value. In some embodiments, the authentication module 210 determines whether an access token should be provided to the edge device 104 based on the integrity measurement value. For example, the authentication module 210 compares the integrity measurement value to a threshold integrity measurement value. If the integrity measurement value meets or exceeds the threshold integrity measurement value, the authentication module 210 determines that an access token should be provided to the edge device 104. The authentication module 210 then causes the access token generation module 212 to generate an access token for the edge device 104, which the authentication module 102 then provides to the edge device 104 at operation 510.

Conversely, if the integrity measurement value does not meet or exceed the threshold integrity measurement value (i.e., the integrity measurement value is below the threshold integrity measurement value), the authentication module 210 determines that an access token should not be provided to the edge device 104. Hence, the authentication request is denied and the edge device 104 is not provided with an access token.

In this type of embodiment, the access token generated by the access token generation module 212 may simply be an access token that is usable by the edge device 104 to request services from the service provider, or an access token appended with additional data. For example, the access token generation module 212 may append the integrity measurement value to the access token or append an integrity measurement value range to the access token. An integrity measurement value range indicates a range of integrity measurement values in which the integrity measurement value lies.

In other embodiments, the authorization module 210 does not compare the integrity measurement value to a threshold integrity measurement value. Rather, the authorization module 210 simply causes the access token generation module 212 to generate an access token for the edge device 104, which is then provided to the edge device 104 at operation 510. In this type of embodiment, the access token generation module 212 appends additional data to the access token, either the integrity measurement value or an integrity measurement value range.

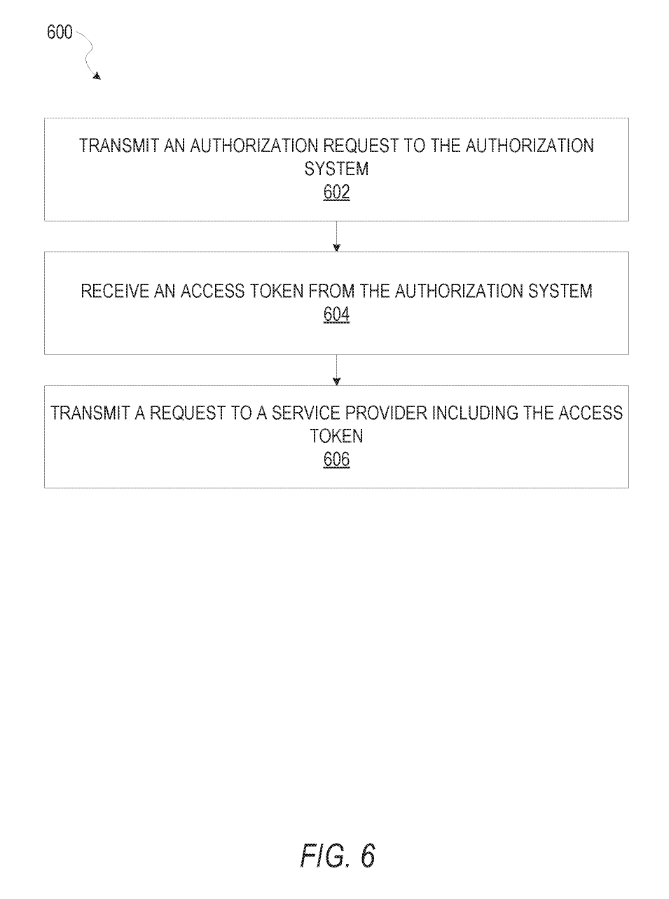

FIG. 6 is a flowchart illustrating a method 600 for requesting a service, according to an example embodiment, The method 600 may be embodied in computer-readable instructions for execution by one or more computer processors such that the operations of the method 600 may be performed in part or in whole by the edge device 104; accordingly, the method 600 is described below by way of example with reference thereto. However, it shall be appreciated that at least some of the operations of the method 600 may be deployed on various other hardware configurations and the method 600 is not intended to be limited to the edge device 104.

At operation 602, the authorization request module 306 transmits an authorization request to the authorization system 102. The authorization request module 306 generates an authorization request when the edge device 104 does not have an access token or has an expired access token. To generate the authorization request, the authorization request module 306 encrypts the unique token assigned to the edge device 104. For example, the authorization request module 306 encrypts the unique token using a private key. Once the unique key is encrypted, the authorization request module 306 transmits the authorization request including the encrypted unique token to the authorization system.

At operation 604, the edge device 104 receives an access token from the authorization system 102. The access token enables the edge device 104 to request services from the service provider 106. The access token has an associated expiration time, after which the access token is no longer valid and therefore cannot be used by the edge device 104 to access services from the service provider 106. Accordingly, the edge device 104 would have to again authenticate with the authentication system 102 to receive a new access token.

At operation 606, the service request module 308 transmits a request to a service provider 106 including the access token. The service provider 106 uses the included access token to determine whether to approve the request.

In embodiments in which the access token is appended with additional data (e.g., the integrity measurement value or the integrity measurement value range), the service provider 106 may use the appended data to determine whether to approve or deny a request received from the edge device 104 for a service provided by the service provider 106. For example, the service provider 106 may compare the integrity measurement value to a threshold integrity measurement value to determine whether to approve or deny the service request. Alternatively, the service provider 106 may compare the integrity measurement value range to a threshold integrity measurement value range to determine whether to approve or deny the service request.

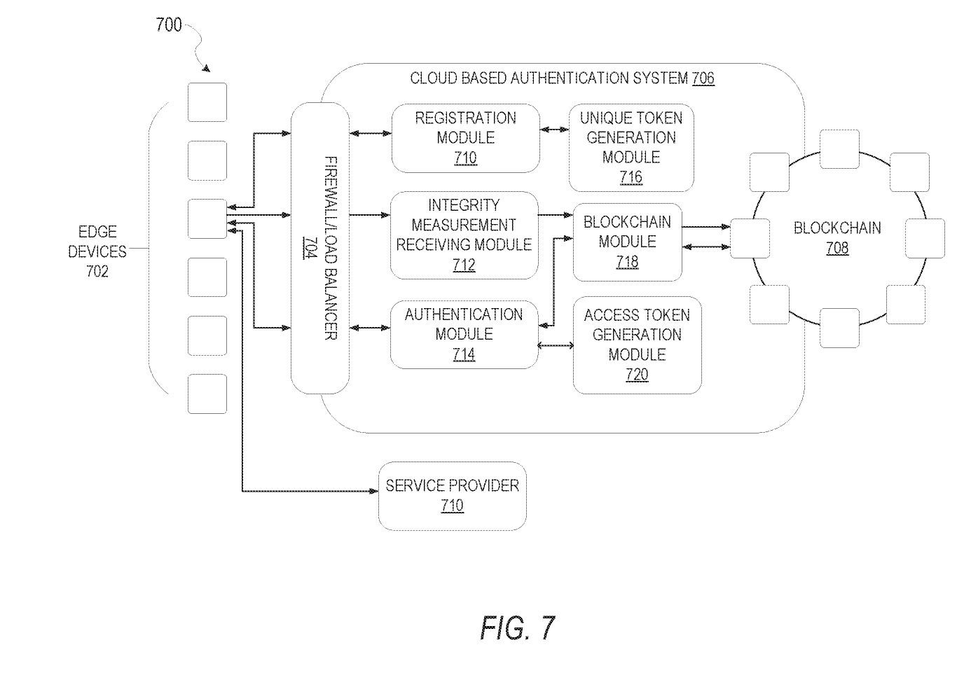

FIG. 7 illustrates a cloud based architecture 700 for authorizing an edge device 702, according to some example embodiments. In the cloud based architecture 700, the edge devices 702 communicate with a cloud based authentication system 706 that manages device authentication to access services provided by a service provider 710. The cloud based authentication system 706 is an industrial cloud based platform as a service (PaaS), such as PREDIX by General Electric (GE) Digital, For example, the cloud based authentication system 706 is a software platform that manages an Industrial Internet of Things (IIOT). That is, the cloud based authentication system 706 supports the IIOT with cloud servers that provide services, such as security, authentication, etc., for edge devices 702 registered with the cloud based authentication system 706.

As shown, an edge device 702 transits a registration request to the cloud based authentication system 706 to initially register with the cloud based authentication system 706. The registration request is initially received by the firewall/load balancer 704, where it is forwarded to the registration module 710. The registration module 710 communicates with the unique token generation module 716 to generate a unique token for the edge device 702. The registration module 710 then returns the unique token to the edge device 702, where it stored for later use to authenticate with the cloud based authentication system 706.

Once registered with the cloud based authentication system 706, an edge device 702 begins periodically transmitting integrity measurement values to the cloud based authentication system 706. The integrity measurement values are received by the firewall/load balancer 704 which forwards them to the integrity measurement receiving module 712. The integrity measurement receiving module 718 then communicates with the blockchain module 718 to have the integrity measurement value stored in the blockchain 708.

To authenticate with the cloud based authentication system 706, the edge device 702 transmits an authentication request to the cloud based authentication system 706. The authentication request includes the unique token assigned to the edge device 702. The authentication request is initially received by the firewall/load balancer 704, which forwards the authentication request to the authentication module 714. The authentication module 714 receives the authentication request and uses the unique token to verify that the edge device 702 has registered with the cloud based authentication system 706.

The authentication module 714 gathers the latest integrity measurement value for the edge device 702. For example, the authentication module 714 communicates with the blockchain module 718 to have the integrity measurement value gathered from the blockchain 708. Once the integrity measurement value has been gathered and the authentication module 714 has authenticated the edge device 702, the authentication module 714 requests an access token from the access token generation module 720. The access token generation module 720 returns the generated access token to the authentication module 714 and the authentication module 714 transmits the access token to the edge device 702. The edge device 702 uses the access token to request services provided by the service provider 710. For example, the edge device 702 includes the access token in requests transmitted to the service provider 710.

### Example Software Architecture

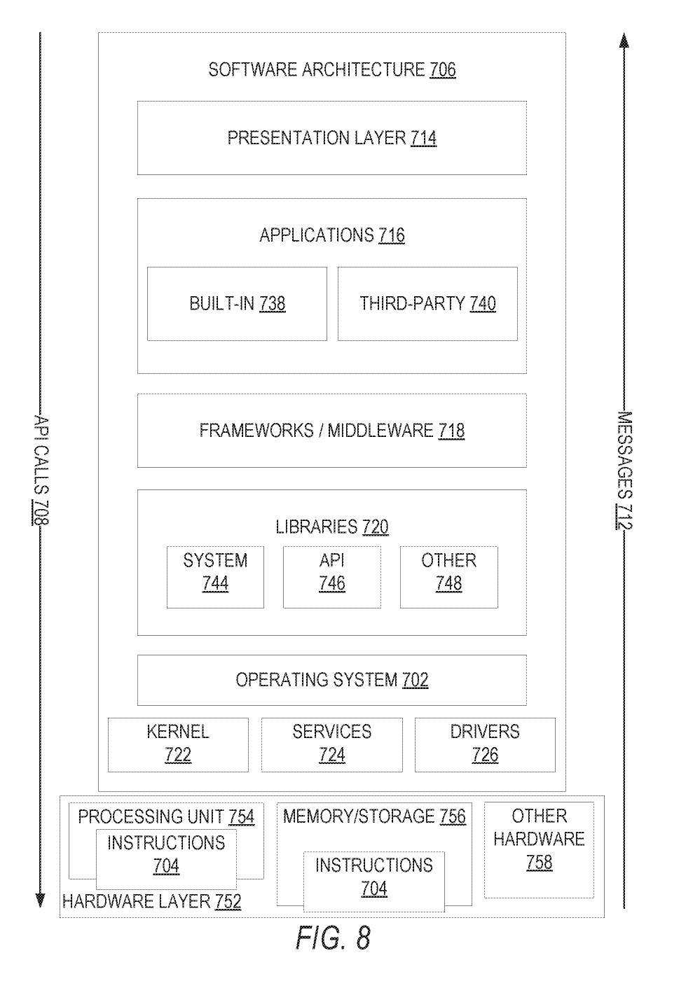

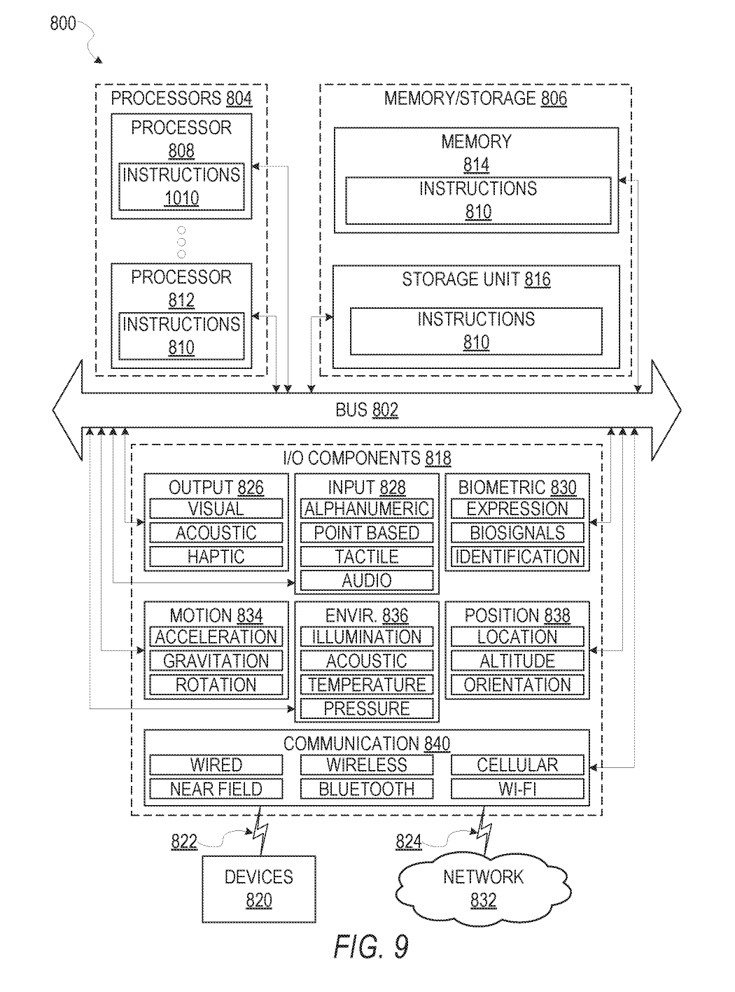

FIG. 8 is a block diagram illustrating an example software architecture 806, which may be used in conjunction with various hardware architectures herein described. FIG. 8 is a non-limiting example of a software architecture and it will be appreciated that many other architectures may be implemented to facilitate the functionality described herein. The software architecture 806 may execute on hardware such as machine 900 of FIG, 9 that includes, among other things, processors 904, memory 914, and I/O components 918. A representative hardware layer 852 is illustrated and can represent, for example, the machine 900 of FIG. 9. The representative hardware layer 852 includes a processing unit 854 having associated executable instructions 804. Executable instructions 804 represent the executable instructions of the software architecture 806, including implementation of the methods, components and so forth described herein. The hardware layer 852 also includes memory and/or storage modules memory/storage 856, which also have executable instructions 804. The hardware layer 852 may also comprise other hardware 858.

In the example architecture of FIG. 8, the software architecture 806 may be conceptualized as a stack of layers where each layer provides particular functionality. For example, the software architecture 806 may include layers such as an operating system 802, libraries 820, applications 816 and a presentation layer 814. Operationally, the applications 816 and/or other components within the layers may invoke Application Programming Interface (API) calls 808 through the software stack and receive a response 812 as in response to the API calls 808. The layers illustrated are representative in nature and not all software architectures have all layers. For example, some mobile or special purpose operating systems may not provide a frameworks/middleware 818, while others may provide such a layer. Other software architectures may include additional or different layers.

The operating system 802 may manage hardware resources and provide common services. The operating system 802 may include, for example, a kernel 822, services 824, and drivers 826. The kernel 822 may act as an abstraction layer between the hardware and the other software layers. For example, the kernel 822 may be responsible for memory management, processor management (e.g., scheduling), component management, networking, security settings, and so on. The services 824 may provide other common services for the other software layers. The drivers 826 are responsible for controlling or interfacing with the underlying hardware. For instance, the drivers 826 may include display drivers, camera drivers, Bluetooth® drivers, flash memory drivers, serial communication drivers (e.g., Universal Serial Bus (USB) drivers), Wi-Fi® drivers, audio drivers, power management drivers, and so forth depending on the hardware configuration.

The libraries 820 provide a common infrastructure that is used by the applications 816 and/or other components and/or layers. The libraries 820 provide functionality that allows other software components to perform tasks in an easier fashion than to interface directly with the underlying operating system 802 functionality (e.g., kernel 822, services 824 and/or drivers 826). The libraries 820 may include system libraries 844 (e.g., C standard library) that may provide functions such as memory allocation functions, string manipulation functions, mathematical functions, and the like. In addition, the libraries 820 may include API libraries 846 such as media libraries (e.g., libraries to support presentation and manipulation of various media format such as MPREG4, H.264, MP3, AAC, AMR, JPG, PNG), graphics libraries (e.g., an OpenGL framework that may be used to render 2D and 3D in a graphic content on a display), database libraries (e.g., SQLite that may provide various relational database functions), web libraries (e.g., WebKit that may provide web browsing functionality), and the like. The libraries 820 may also include a wide variety of other libraries 848 to provide many other APIs to the applications 816 and other software components/modules.

The frameworks/middleware 818 (also sometimes referred to as middleware) provide a higher-level common infrastructure that may be used by the applications 816 and/or other software components/modules. For example, the frameworks/middleware 818 may provide various graphic user interface (GUI) functions, high-level resource management, high-level location services, and so forth. The frameworks/middleware 818 may provide a broad spectrum of other APIs that may be utilized by the applications 816 and/or other software components/modules, some of which may be specific to a particular operating system 802 or platform.

The applications 816 include built-in applications 838 and/or third-party applications 840. Examples of representative built-in applications 838 may include, but are not limited to, a contacts application, a browser application, a book reader application, a location application, a media application, a messaging application, and/or a game application. Third-party applications 840 may include an application developed using the ANDRGID™ or IOS™ software development kit (SDK) by an entity other than the vendor of the particular platform, and may be mobile software running on a mobile operating system such as IOS™, ANDROID™, WINDOWS® Phone, or other mobile operating systems. The third-party applications 840 may invoke the API calls 808 provided by the mobile operating system (such as operating system 802) to facilitate functionality described herein.

The applications 816 may use built in operating system functions (e.g., kernel 822, services 824, and/or drivers 826), libraries 820, and frameworks/middleware 818 to create user interfaces to interact with users of the system. Alternatively, or additionally, in some systems interactions with a user may occur through a presentation layer, such as presentation layer 814. In these systems, the application/component “logic” can be separated from the aspects of the application/component that interact with a user.

### Example Machine Architecture and Machine-Readable Medium

FIG. 9 is a block diagram illustrating components of a machine 900, according to some example embodiments, able to read instructions from a machine-readable medium (e.g., a machine-readable storage medium) and perform any one or more of the methodologies discussed herein. Specifically, FIG. 9 shows a diagrammatic representation of the machine 900 in the example form of a computer system, within which instructions 910 (e.g., software, a program, an application, an applet, an app, or other executable code) for causing the machine 900 to perform any one or more of the methodologies discussed herein may be executed. As such, the instructions 910 may be used to implement modules or components described herein. The instructions 910 transform the general, non-programmed machine 900 into a particular machine 900 programmed to carry out the described and illustrated functions in the manner described. In alternative embodiments, the machine 900 operates as a standalone device or may be coupled (e.g., networked) to other machines. In a networked deployment, the machine 900 may operate in the capacity of a server machine or a client machine in a server-client network environment, or as a peer machine in a peer-to-peer (or distributed) network environment. The machine 900 may comprise, but not be limited to, a server computer, a client computer, a personal computer (PC), a tablet computer, a laptop computer, a netbook, a set-top box (STB), a personal digital assistant (PDA), an entertainment media system, a cellular telephone, a smart phone, a mobile device, a wearable device (e.g., a smart watch), a smart home device (e.g., a smart appliance), other smart devices, a web appliance, a network router, a network switch, a network bridge, or any machine capable of executing the instructions 910, sequentially or otherwise, that specify actions to be taken by machine 900. Further, while only a single machine 900 is illustrated, the term “machine” shall also be taken to include a collection of machines that individually or jointly execute the instructions 910 to perform any one or more of the methodologies discussed herein.

The machine 900 may include processors 904, memory memory/storage 906, and I/O components 918, which may be configured to communicate with each other such as via a bus 902. The memory/storage 906 may include a memory 914, such as a main memory, or other memory storage, and a storage unit 916, both accessible to the processors 904 such as via the bus 902. The storage unit 916 and memory 914 store the instructions 910 embodying any one or more of the methodologies or functions described herein. The instructions 910 may also reside, completely or partially, within the memory 914, within the storage unit 916, within at least one of the processors 904 (e.g., within the processor's cache memory), or any suitable combination thereof, during execution thereof by the machine 900. Accordingly, the memory 914, the storage unit 916, and the memory of processors 904 are examples of machine-readable media.

The I/O components 918 may include a wide variety of components to receive input, provide output, produce output, transmit information, exchange information, capture measurements, and so on. The specific I/O components 918 that are included in a particular machine 900 will depend on the type of machine. For example, portable machines such as mobile phones will likely include a touch input device or other such input mechanisms, while a headless server machine will likely not include such a touch input device. It will be appreciated that the I/O components 918 may include many other components that are not shown in FIG. 9. The I/O components 918 are grouped according to functionality merely for simplifying the following discussion and the grouping is in no way limiting. In various example embodiments, the I/O components 918 may include output components 926 and input components 928. The output components 926 may include visual components (e.g., a display such as a plasma display panel (PDP), a light emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The input components 928 may include alphanumeric input components (e.g., a keyboard, a touch screen configured to receive alphanumeric input, a photo-optical keyboard, or other alphanumeric input components), point based input components (e.g., a mouse, a touchpad, a trackball, a joystick, a motion sensor, or other pointing instrument), tactile input components (e.g., a physical button, a touch screen that provides location and/or force of touches or touch gestures, or other tactile input components), audio input components (e.g., a microphone), and the like.

In further example embodiments, the I/O components 918 may include biometric components 930, motion components 934, environmental components 936, or position components 938 among a wide array of other components. For example, the biometric components 930 may include components to detect expressions (e.g., hand expressions, facial expressions, vocal expressions, body gestures, or eye tracking), measure biosignals (e.g., blood pressure, heart rate, body temperature, perspiration, or brain waves), identify a person (e.g., voice identification, retinal identification, facial identification, fingerprint identification, or electroencephalogram based identification), and the like. The motion components 934 may include acceleration sensor components (e.g., accelerometer), gravitation sensor components, rotation sensor components (e.g., gyroscope), and so forth. The environmental components 936 may include, for example, illumination sensor components (e.g., photometer), temperature sensor components (e.g., one or more thermometer that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detection concentrations of hazardous gases for safety or to measure pollutants in the atmosphere), or other components that may provide indications, measurements, or signals corresponding to a surrounding physical environment. The position components 938 may include location sensor components (e.g., a Global Position system (GPS) receiver component), altitude sensor components (e.g., altimeters or barometers that detect air pressure from which altitude may be derived), orientation sensor components (e.g., magnetometers and the like.

Communication may be implemented using a wide variety of technologies. The I/O components 918 may include communication components 940 operable to couple the machine 900 to a network 932 or devices 920 via coupling 922 and coupling 924, respectively. For example, the communication components 940 may include a network interface component or other suitable device to interface with the network 932. In further examples, communication components 940 may include wired communication components, wireless communication components, cellular communication components, Near Field Communication (NFC) components, Bluetooth® components (e.g., Bluetooth® Low Energy), Wi-Fi® components, and other communication components to provide communication via other modalities. The devices 920 may be another machine or any of a wide variety of peripheral devices (e.g., a peripheral device coupled via a USB).

Moreover, the communication components 940 may detect identifiers or include components operable to detect identifiers. For example, the communication components 940 may include Radio Frequency Identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph, MaxiCode PDF417, Ultra Code, UCC RSS-2D bar code, and other optical codes or acoustic detection components (e.g., microphones to identify tagged audio signals). In addition, a variety of information may be derived via the communication components 940, such as, location via IP geo-location, location via Wi-Fi® signal triangulation, location via detecting a NFC beacon signal that may indicate a particular location, and so forth.

### Transmission Medium

In various example embodiments, one or more portions of the network 932 may be an ad hoc network, an intranet, an extranet, a virtual private network (VPN), a local area network (LAN), a wireless LAN (WEAN), a wide area network (WAN), a wireless WAN (WWAN), a metropolitan area network (MAN), the Internet, a portion of the Internet, a portion of the Public Switched Telephone Network (PSTN), a plain old telephone service (POTS) network, a cellular telephone network, a wireless network, a Wi-Fi® network, another type of network, or a combination of two or more such networks. For example, the network 932 or a portion of the network 932 may include a wireless or cellular network and the coupling 924 may be a Code Division Multiple Access (CDMA) connection, a Global System for Mobile communications (GSM) connection, or another type of cellular or wireless coupling. In this example, the coupling 824 may implement any of a variety of types of data transfer technology, such as Single Carrier Radio Transmission Technology (1×RTT), Evolution-Data Optimized (EVDO) technology, General Packet Radio Service (CPRS) technology, Enhanced Data rates for GSM Evolution (EDGE) technology, third Generation Partnership Project (3GPP) including 3G, fourth generation wireless (4G) networks, Universal Mobile Telecommunications System (UMTS), High-Speed Packet Access (HSPA), Worldwide Interoperability for Microwave Access (WiMAX), Long-Term Evolution (LTE) standard, others defined by various standard-setting organizations, other long-range protocols, or other data-transfer technology.

The instructions 810 may be transmitted or received over the network 832 using a transmission medium via a network interface device (e.g., a network interface component included in the communication components 840) and utilizing any one of a number of well-known transfer protocols (e.g., HTTP). Similarly, the instructions 810 may be transmitted or received using a transmission medium via the coupling 82 (e.g., a peer-to-peer coupling) to the devices 820. The term “transmission medium” shall be taken to include any intangible medium that is capable of storing, encoding, or carrying the instructions 810 for execution by the machine 800, and includes digital or analog communications signals or other intangible media to facilitate communication of such software.

### Language

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Although an overview of the inventive subject matter has been described with reference to specific example embodiments, various modifications and changes may be made to these embodiments without departing from the broader scope of embodiments of the present disclosure. Such embodiments of the inventive subject matter may be referred to herein, individually or collectively, by the term “invention” merely for convenience and without intending to voluntarily limit the scope of this application to any single disclosure or inventive concept if more than one is, in fact, disclosed.

The embodiments illustrated herein are described in sufficient detail to enable those skilled in the art to practice the teachings disclosed. Other embodiments may be used and derived therefrom, such that structural and logical substitutions and changes may be made without departing from the scope of this disclosure. The Detailed Description, therefore, is not to be taken in a limiting sense, and the scope of various embodiments is defined only by the appended claims, along with the full range of equivalents to which such claims are entitled.

As used herein, the term “or” may be construed in either an inclusive or exclusive sense. Moreover, plural instances may be provided for resources, operations, or structures described herein as a single instance. Additionally, boundaries between various resources, operations, modules, engines, and data stores are somewhat arbitrary, and particular operations are illustrated in a context of specific illustrative configurations. Other allocations of functionality are envisioned and may fall within a scope of various embodiments of the present disclosure. In general, structures and functionality presented as separate resources in the example configurations may be implemented as a combined structure or resource. Similarly, structures and functionality presented as a single resource may be implemented as separate resources. These and other variations, modifications, additions, and improvements fall within a scope of embodiments of the present disclosure as represented by the appended claims. The specification and drawings are, accordingly, to be regarded in an illustrative rather than a restrictive sense.

What is claimed is:

1. A method comprising:
receiving, from a device, an authentication request, the authentication request including a unique token assigned to the device that has been encrypted using a private key;
in response to receiving the request:
verifying, by one or more computer processors of an authentication system, and based on the unique token received in the authentication request, that the device is registered with the authentication system, and
accessing, from a blockchain, integrity measurement information for the device, the integrity measurement information having been previously generated in connection with the device;
generating an access token for the device factoring in the integrity measurement information; and
providing the access token to the device, the access token providing the device with access to at least a first service.

2. The method of claim 1, wherein generating the access token factoring in the integrity measurement information comprises:
appending at least part of the integrity measurement information to the access token.

3. The method of claim 1, wherein generating the access token factoring in the integrity measurement information comprises:
determining that the integrity measurement information includes information that satisfies a threshold integrity information criteria.

4. The method of claim 1, wherein generating the access token factoring in the integrity measurement information comprises:
determining additional integrity criteria based on the integrity measurement information; and
appending data identifying the additional integrity criteria to the access token.

5. The method of claim 1, wherein the device transmits the access token to a service provider as part of a request for a service provided by the service provider, the service provider using the access token to determine whether to provide the service to the device.

6. The method of claim 1, further comprising:
receiving, from the device, at least a portion of the integrity measurement information; and
updating the security blockchain based on the integrity measurement information.

7. The method of claim 1, further comprising:
decrypting the unique token received in the authorization request using a public key.

8. An authorization system comprising:
one or more computer processors; and
one or more computer-readable mediums storing instructions that, when executed by the one or more computer processors, cause the authorization system to perform operations comprising:
receiving, from a device, an authentication request, the authentication request including a unique token assigned to the device that has been encrypted using a private key;
in response to receiving the request:
verifying, based on the unique token received in the authentication request, that the device is registered with the authentication system, and
accessing, from a blockchain, integrity measurement information for the device, the integrity measurement information having been previously generated in connection with the device;
generating an access token for the device factoring in the integrity measurement information; and
providing the access token to the device, the access token providing the device with access to at least a first service.

9. The authorization system of claim 8, wherein generating the access token factoring in the integrity measurement information comprises:
appending at least part of the integrity measurement information to the access token.

10. The authorization system of claim 8, wherein generating the access token factoring in the integrity measurement information comprises:
determining that the integrity measurement information includes information that satisfies a threshold integrity information criteria.

11. The authorization system of claim 8, wherein generating the access token factoring in the integrity measurement information comprises:
determining additional integrity criteria based on the integrity measurement information; and
appending data identifying the additional integrity criteria to the access token.

12. The authorization system of claim 8, wherein the device transmits the access token to a service provider as part of a request for a service provided by the service provider, the service provider using the access token to determine whether to provide the service to the device.

13. The authorization system of claim 8, the operations further comprising:
receiving, from the device, at least a portion of the integrity measurement information; and
updating the security blockchain based on the integrity measurement information.

14. The authorization system of claim 8, the operations further comprising:
decrypting the unique token received in the authorization request using a public key.

15. A non-transitory computer-readable medium storing instructions that, when executed by one or more computer processors of an authorization system, cause the authorization system to perform operations comprising:
receiving, from a device, an authentication request, the authentication request including a unique token assigned to the device that has been encrypted using a private key;
in response to receiving the request:
verifying, based on the unique token received in the authentication request, that the device is registered with the authentication system, and
accessing, from a blockchain, integrity measurement information for the device, the integrity measurement information having been previously generated in connection with the device;
generating an access token for the device factoring in the integrity measurement information; and
providing the access token to the device, the access token providing the device with access to at least a first service.

16. The non-transitory computer-readable medium of claim 15, wherein generating the access token factoring in the integrity measurement information comprises:
appending at least part of the integrity measurement information to the access token.

17. The non-transitory computer-readable medium of claim 15, wherein generating the access token factoring in the integrity measurement information comprises:
determining that the integrity measurement information includes information that satisfies a threshold integrity information criteria.

18. The non-transitory computer-readable medium of claim 15, wherein generating the access token factoring in the integrity measurement information comprises:
determining additional integrity criteria based on the integrity measurement information; and
appending data identifying the additional integrity criteria to the access token.

19. The non-transitory computer-readable medium of claim 15, wherein the device transmits the access token to a service provider as part of a request for a service provided by the service provider, the service provider using the access token to determine whether to provide the service to the device.

20. The non-transitory computer-readable medium of claim 15, the operations further comprising:
receiving, from the device, at least a portion of the integrity measurement information; and
updating the security blockchain based on the integrity measurement information.
